(19) United States
(12) Patent Application Publication
(10) Pub. No.: US 2015/0339711 A1
(43) Pub. Date: Nov. 26, 2015

(54) TARGETED PROMOTIONS

(71) Applicants: Praveen Katakam, Cedar Park, TX (US); Kamal Zamer, Austin, TX (US); Praveen Nuthulapati, Austin, TX (US)

(72) Inventors: Praveen Katakam, Cedar Park, TX (US); Kamal Zamer, Austin, TX (US); Praveen Nuthulapati, Austin, TX (US)

(73) Assignee: EBAY INC., SAN JOSE, CA (US)

(21) Appl. No.: 14/283,907

(22) Filed: May 21, 2014

(51) Int. Cl. G06Q 30/02; G06Q 50/00

(52) U.S. Cl. CPC G06Q 30/0255; G06Q 30/0261; G06Q 50/01

(57) ABSTRACT

A device monitors conversations of one or more users. The device may be targeted to a particular user or a particular area. Based on the words of a conversation and the speaker of the words, an interest in a product of one or more of the participants in the conversation may be identified. Based on the user's interest in a product and the identification of another party to the conversation, promotions for the product may be sent to the other party. The influence of one participant on another can be quantized in an influence score. The importance of a conversation to a prospective buyer can be quantized in a conversation score. The influence score and conversation score may be used in determining whether to send a promotion to a party to the conversation.

### TECHNICAL FIELD

The subject matter disclosed herein generally relates to the processing of data. In one specific example, the present disclosure addresses systems and methods related to targeted promotions.

### BACKGROUND

A social networking system may provide an interface for users to communicate with each other. A social networking system may also provide a platform to facilitate the presentation of advertisements or promotions to the users.

### BRIEF DESCRIPTION OF THE DRAWINGS

Some embodiments are illustrated by way of example and not limitation in the figures of the accompanying drawings.

FIG. 1 is a network diagram illustrating a network environment suitable for targeted promotions, according to some example embodiments.

FIG. 2 is a block diagram illustrating components of an application server suitable for targeted promotions, according to some example embodiments.

FIG. 3 is a block diagram illustrating components of a device suitable for targeted promotions, according to some example embodiments.

FIG. 4 is a block diagram illustrating a user interface suitable for targeted promotions, according to some example embodiments.

FIG. 5 is a block diagram illustrating a user interface suitable for targeted promotions, according to some example embodiments.

FIG. 6 is an equation used in a method for targeted promotions, according to some example embodiments.

FIG. 7 is a data diagram illustrating data structures suitable, according to some example embodiments, for targeted promotions.

FIG. 8 is a flow diagram illustrating operations of a method for targeted promotions, according to some example embodiments.

FIG. 9 is a flow diagram illustrating operations of a method for targeted promotions, according to some example embodiments.

FIG. 10 is a flow diagram illustrating operations of a method for targeted promotions, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to targeted promotions. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A device monitors conversations of one or more users. For example, the device may be a smart phone, a wearable device, a smart appliance, or another computing device. In some example embodiments, the device monitors the conversations through an embedded microphone. In other example embodiments, audio input is taken through a microphone connected by wire or wirelessly to the computing device. The device may be targeted to a particular user or a particular area. For example, a wearable device may target the conversations of the user who wears the device. As another example, a smart appliance may monitor conversations in the room in which the appliance is located. A conversation is a type of communication. Other types of communication include email, text messaging, and social media. The discussion herein primarily relates to conversations, but may be applied to any form of communication, unless otherwise indicated by context.

Words within the conversations can be recognized using standard voice-recognition techniques. For text-based communications, words can be recognized directly. Based on the words of the conversation and the speaker of the words, an interest in a product by one or more of the participants in the conversation may be identified. For example, a user may say that he wants to “buy a car” and is “thinking about a Honda.” Accordingly, an interest of the user in Honda vehicles can be identified. Similarly, support or opposition to the product can be identified. For example, the other participant in the conversation may say that “my Honda is great” or “no, GM is better.”

The participants to the conversation can be identified in a number of ways. For example, voice recognition can be used to identify the participants by voiceprint. As another example, multiple devices may each be associated with different individuals (e.g., each person may carry a smart phone). Based on the location of the devices being the same or within a certain proximity (e.g., six feet), a determination can be made that one participant is the user associated with the monitoring device and another participant is the user associated with the device in close proximity. For electronic communications, the identity of each participant may be associated with the words of the participant as part of the communication process.

Based on the user's interest in a product and the identification of another party to the conversation, promotions for the product may be sent to the other party. For example, a husband and wife discuss interest in a car primarily intended for the husband's use. After the conversation, a promotion for the car can be sent to the husband, the wife, or both.

The influence of one participant on another can be quantized in an influence score. The influence score may be based on the relationship between the parties, the amount of time the parties spend together, the impact of past recommendations from one party to the other, and other factors. In some example embodiments, promotions are presented to other participants in a conversation only if the influence score of that participant on the prospective buyer exceeds a threshold.

The importance of a conversation to a prospective buyer can be quantized in a conversation score. The conversation score may be based on the relationship between the parties, the location of the conversation, the words of the conversation, and other factors. In some example embodiments, promotions are presented in response to a conversation only if the conversation score exceeds a threshold.

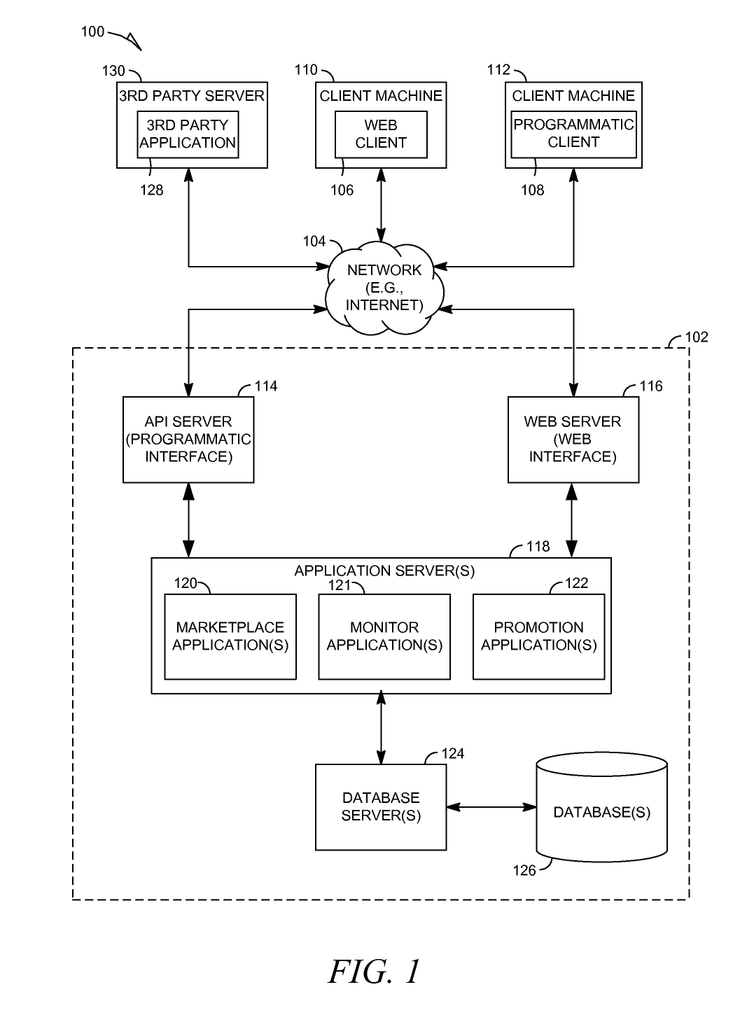

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120, monitor applications 121, and promotion applications 122. The application servers 118 are, in turn, shown to be coupled to one or more databases servers 124 that facilitate access to one or more databases 126.

The marketplace applications 120 may provide a number of marketplace functions and services to users that access the networked system 102. The monitor applications 121 may provide monitoring functions and services to users that access the networked system 102. The monitor applications 121 may allow users to have their conversations monitored to identify products of interest. The monitor applications 121 may be linked to or part of the marketplace applications 120. Accordingly, searches may be run by the monitor application 121 to find items for sale through the marketplace applications 120. The promotion applications 122 may likewise provide promotion services and functions to users. The promotion applications 122 may provide promotions to users for products (e.g., goods or services) that are made available via the marketplace applications 120. While the marketplace, monitor, and promotion applications 120, 121, and 122 are shown in FIG. 1 to each form part of the networked system 102, it will be appreciated that, in alternative embodiments, the monitor applications 121 may form part of a monitoring service that is separate and distinct from the networked system 102. Likewise, the promotion applications 122 may form part of a promotion service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace, monitor, and promotion applications 120, 121, and 122 could also be implemented as standalone software programs, which do not necessarily have networking capabilities.

The web client 106 accesses the various marketplace, monitor, and promotion applications 120, 121, and 122 via the web interface supported by the web server 116. Similarly, the programmatic client 108 accesses the various services and functions provided by the marketplace, monitor, and promotion applications 120, 121, and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102. As another example, the programmatic client 108 may be a search application to enable users to search for items. The items searched for may be informational items (e.g., news articles, blogs, images, multimedia content, etc.), transactional items (e.g., items for sale online, items for sale in brick-and-mortar locations, items wanted online, items wanted in brick-and-mortar locations), or other types of items.

The client machine 110 or 112 may present information to a user. For example, the client machine 110 may be running a web browser presenting a web page. The user may indicate a search query to the client machine 110. A search query defines the parameters of a search. The client machine 110 or 112 may submit the search query to an application server 118 running a search application 121. For example, the user may enter a search string into a hypertext markup language (HTML) form and press a button to cause the submission of the search query to an application server. The search query may be transmitted using hypertext transport protocol (HTTP) over transmission control protocol/Internet protocol (TCP/IP). The application server 118 may send the results of the search query back to the client machine 110 or 112. The client machine 110 or 112 may present the search results received from the application server 118 to the user.

The client machine 110 or 112 may present options to the user to configure the monitoring application. For example, the user may allow monitoring only at certain locations, exclude monitoring at certain locations, allow monitoring only at certain times, or exclude monitoring at certain times. For example, monitoring could be allowed only when not at work or home, enabled only during the hours of 9 AM-5 PM, Monday to Friday, or both. Similarly, monitoring may be enabled based on the type of communication being monitored. For example, monitoring of electronic communications may always be allowed while monitoring of conversations is allowed only during specified times.

The client machine 110 or 112 may present promotions to the user. A promotion is an advertisement, coupon, or discount for a product or service. The client machine 110 or 112 may enable the user to send the promotion to another user. For example, the promotion may be sent through an instant messaging (IM) service, a text message service (e.g., SMS), email, or social media network.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, search, or payment functions that are supported by the relevant applications of the networked system 102.

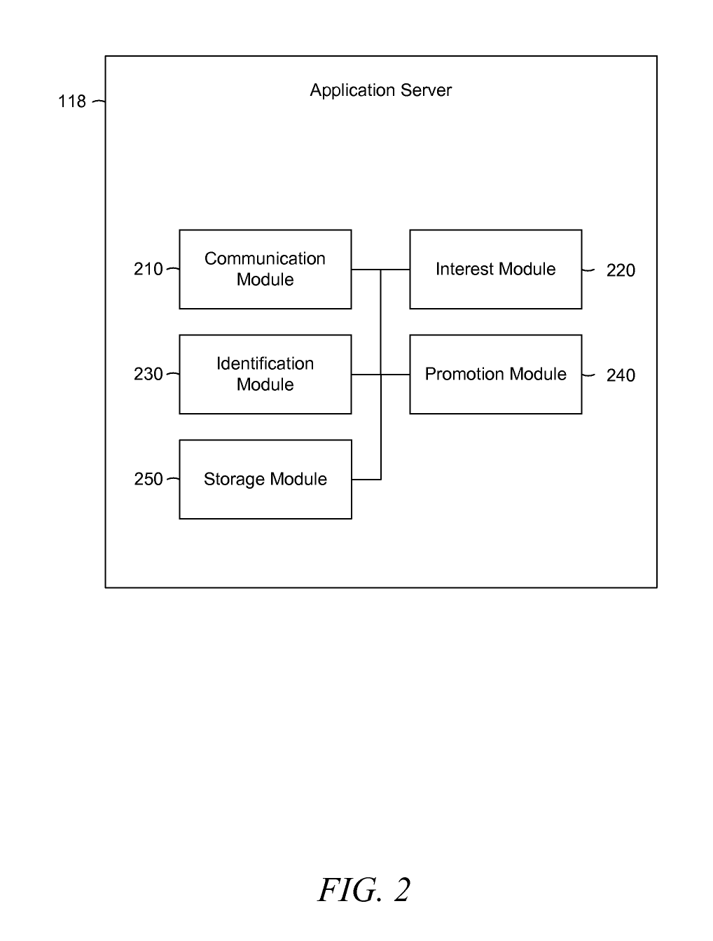

FIG. 2 is a block diagram illustrating components of an application server 118 running one or more monitoring application(s) 121 or promotion application(s) 122, according to some example embodiments. The application server 118 is shown as including a communication module 210, an interest module 220, an identification module 230, a promotion module 240, and a storage module 250, all configured to communicate with each other (e.g., via a bus, shared memory, a switch, or APIs). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 can control communication with the client machine 110, the database 126, the monitor application 121, and other computers and devices. The communication module 210 may also send data for storage on the application server 118 or the database 126.

The communication module 210 can receive requests from the monitor application 121 to generate a promotion for a user. For example, the monitor application 121 may provide a user identifier of the user to receive a promotion along with keywords identified by monitoring the user. The communication module 210 may send these items to the interest module 220 to identify interests of the user and the promotion module 240 to identify a promotion targeted to the user. The communication module 210 can also send the received items to the storage module 250 for future retrieval.

The interest module 220 may access a database (e.g., database 126) to identify interests of the identified user. The interests can be identified based on keywords contained in the conversation monitored by the monitoring application 121. For example, the database 126 may contain mappings between keywords and interests. By using the keywords detected in a monitored conversation, the corresponding interests can be identified. For example, keywords for “bike,” “hog,” and “chopper” may all map to an interest in “motorcycles.”

The identification module 230 can identify one or more parties to a conversation. For example, the communication module 210 can receive raw sound data for the conversation. The communication module 210 can forward the raw sound data to the identification module 230. The raw sound data can be analyzed to identify discrete voices in the conversation. A voice print for each voice in the conversation can be generated and compared to a database of voice prints to identify the parties to the conversation.

As another example, the communication module 210 can receive identifying data for one or more devices recording the conversation. The communication module 210 can forward the identifying data to the identification module 230. Based on the identifying data for the device, a user associated with the device can be identified as a participant in the conversation. For example, a database record mapping a unique identifier for a device to a user may be accessed to identify the user.

The promotion module 240 may select one or more promotions based on the interests identified by the interest module 220. For example, each of the identified interests may be associated with zero or more promotions. An affinity between the interests and the other parties to the monitored conversation may be determined. Based on the affinity of each interest, the associated promotions of the interests can be ranked. The n top-ranked promotions may be selected for presentation by the promotion module 240.

The promotion module 240 may determine whether or not to present promotions, and how many promotions to present, based on a Conversation Score. The Conversation Score may be calculated using equation 600, discussed in more detail below. The Conversation Score for a monitored conversation may be compared to one or more thresholds to determine the appropriate response. For example, a Conversation Score between 0 and 0.5 may result in no promotions being presented; a Conversation Score between 0.5 and 0.6 may result in one promotion being presented; a Conversation Score between 0.6 and 0.75 may result in two promotions being presented; and a Conversation Score above 0.75 may result in three promotions being presented.

The communication module 210 can send the promotions selected by the promotion module 240 to the client machine 110 or 112 for display to the user. Additionally or alternatively, the communication module 210 may send the promotions selected by the promotion module 240 to another client machine associated with another party to the conversation for presentation to the other party.

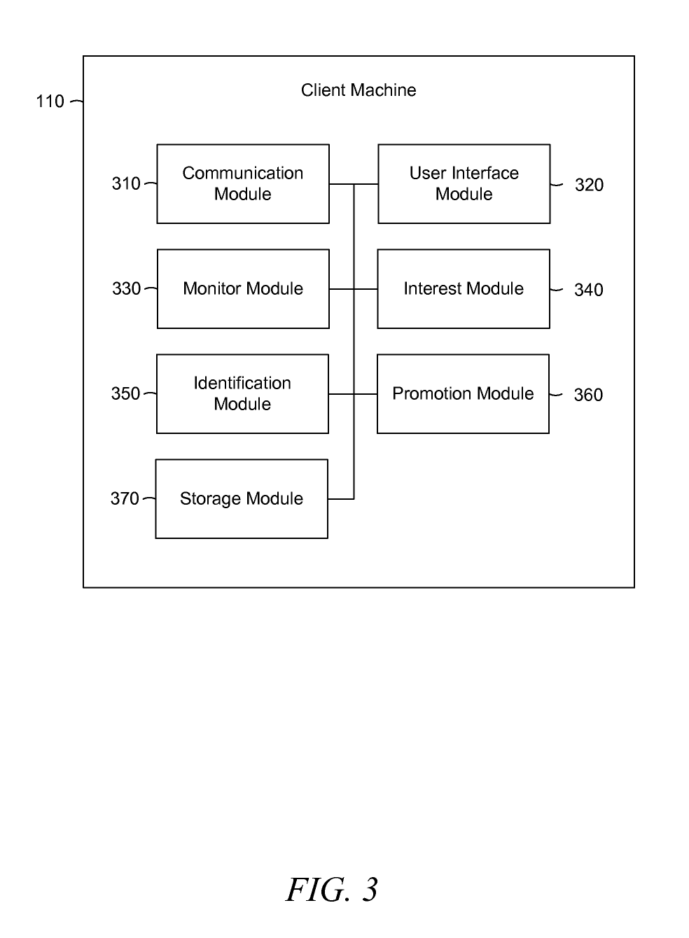

FIG. 3 is a block diagram illustrating components of a client machine suitable for targeted promotions, according to some example embodiments. The client machine 110 or 112 is shown as including a communication module 310, a user interface module 320, a monitor module 330, an interest module 340, an identification module 350, a promotion module 360, and a storage module 370, configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 310 may communicate with the application server 118, the network 104, or any suitable combination thereof. Information received via the communication module 310 may be presented (e.g., displayed on a display device) via the user interface module 320. For example, the user interface module 320 may implement a web browser running on a general-purpose processor causing the display of information on a display device, such as a monitor.

Configuration options or targeted promotions may be presented to the user via the user interface module 320. For example, user interface options may be presented that allow the user to control when and where monitoring takes place. As another example, promotions generated in response to the monitoring of the user may be presented. The promotions may be interacted with by the user to cause the presentation of additional information regarding the promotion. For example, a promotion may include a click-through link that causes a web browser to present a web page for the promoted product or service. The promotions may include codes or printable coupons usable by the user to receive a discount or free product.

In some example embodiments, the application server 118 provides a larger number of promotions than the user interface module 320 is configured to display. For example, the application server 118 may select five promotions, while the user interface module 320 may be configured to display no more than three recommendations. In these embodiments, the user interface module 320 may select the desired number of recommendations from the recommendations provided by the application server 118. For example, the five promotions may be ranked and the user interface module 320 may select the three highest-ranked promotions for presentation.

The monitor module 330 can monitor the conversations occurring near the client machine 110. For example, a microphone attached to the client machine 110 can detect and receive sound near the client machine 110. The monitor module 330 may convert the received sound to text using a text-to-speech algorithm. The text of the conversation can be transmitted to a monitoring application 121 using the communication module 310. In some example embodiments, the sound is transmitted to the monitoring application 121 and conversions take place on the application server 118.

The monitor module 330 may monitor the conversations occurring near the client machine 110 to identify a keyword that triggers further processing. For example, recording may be triggered by detection of a word such as “buy” or “sell.” Detection of such a keyword may provide a basis for determining that the conversation regards commerce, and thus that future words in the conversation may indicate a particular item or item category of interest to one or more participants in the conversation.

The interest module 340 can operate in a manner similar to the interest module 220, discussed above with respect to FIG. 2. In some example embodiments, identification of user interests occurs on the client machine 110 using the interest module 340. In other example embodiments, identification of user interests occurs on the application server 118 using the interest module 220. In still other example embodiments, a user manually enters interests using a user interface presented by the user interface module 320.

The identification module 350 may identify the participants in the monitored conversation. For example, the client machine 110 or 112 can be associated with a particular user. The identification module 350 may assume that the associated user is a participant in the conversation. As another example, separate voices in the conversation can be identified and compared against a database of voiceprints of known users. When matches are found, the participants in the conversation are identified. Alternatively or additionally, other participants in the conversation may also be associated with computing devices. The computing devices may be identified by the identification module 350 using peer-to-peer networking (e.g., using BlueTooth) or through client-server communications. For example, the client machine 110 or 112 associated with the user and including the identification module 350 may be in communication with the application server 118. A computing device associated with another participant in a conversation with the user may also be in communication with the application server 118. By identifying the location of the client machine 110 or 112 in regards to the application server 118, the application server 118 can correlate the location of the client machine 110 or 112 with the location of the computing device associated with the other participant in the conversation. By determining the proximity of the two devices, the application server 118 can inform the monitor module 330 of the identity of the other participant in the conversation (in this case, by assuming that the other participant is the individual associated with the computing device in close proximity to the conversation).

The promotion module 360 can operate in a manner similar to the promotion module 240, discussed above with respect to FIG. 2. In some example embodiments, identification of targeted promotions occurs on the client machine 110 using the promotion module 360. In other example embodiments, identification of targeted promotions occurs on the application server 118 using the promotion module 240.

The storage module 370 can store data on the client machine 110 for use by the other modules 310-350. For example, configuration data defined by the user using the user interface module 320 can be stored using the storage module 370 for access by the monitor module 330 when determining whether or not to monitor conversations. As another example, interests identified by the interest module 340 during a first conversation may be stored by the storage module 370. During a later conversation, the previously-identified interests stored by the storage module 370 may be accessed by the interest module 340 when determining the interests indicated during the later conversation by the monitor module 330. For example, the interest module 340 may give a greater weight to an indicated interest if it has appeared in a previous conversation.

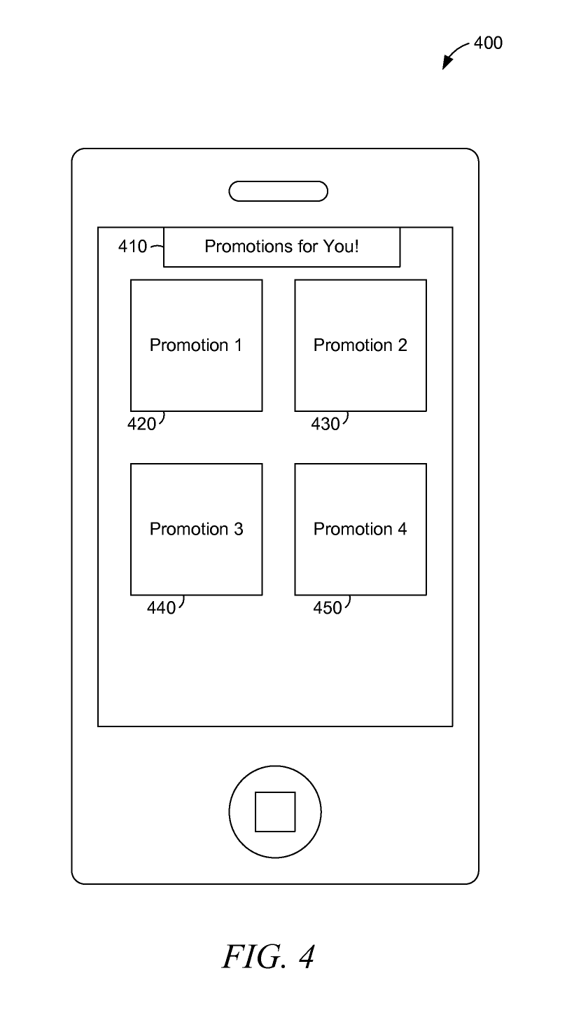

FIG. 4 is a block diagram illustrating a user interface 400 suitable for targeted promotions, according to some example embodiments. As can be seen in the block diagram of FIG. 4, the user interface 400 includes title 410, and targeted promotions 420-450.

Each targeted promotion 420-450 may be operable to view additional information about the targeted promotion. For example, a targeted promotion may be for an item for sale and the initial targeted promotion screen may show an image of the item and a label. Clicking on the image of the item may result in a web page being displayed that shows additional information about the item, such as an item description, additional images, a price, and so on. The targeted promotions 420-450 may include items, events, locations, people, and so on. Items may be items for sale or items that are wanted for purchase. Events may be concerts, festivals, movies, sporting events, and the like. Locations may be monuments, stores, gas stations, restaurants, stadiums, and the like. People may be friends of the user, celebrities, or other people. In some example embodiments, one or more of the items, events, locations, or people displayed is chosen based on an advertising fee paid.

The targeted promotions 420-450 may include buttons that are operable by the recipient of the promotion to respond to the targeted promotions or send the targeted promotions to another recipient. The targeted promotions 420-450 may include images or text presenting information about the targeted promotions. For example, an image of an item involved in the promotion may be presented, a name of the promotion may be presented, a time remaining for the promotion may be presented, and so on. When information about an item is presented, that information may include an image of the item, a price of the item, a brand of the item, an aspect of the listing for the item, a name of a seller of the item, and so on. The price of the item may be a promotional price (e.g., a reduced price) for the item, a non-promotional price for the item, or both. When multiple prices for the item are displayed, the promotional price may be highlighted (e.g., displayed in a larger font, in a different color, using underlining, using bold, and so on). Similarly, the original price may be diminished (e.g., displayed in a smaller font, in a different color, using strikethrough, and so on).

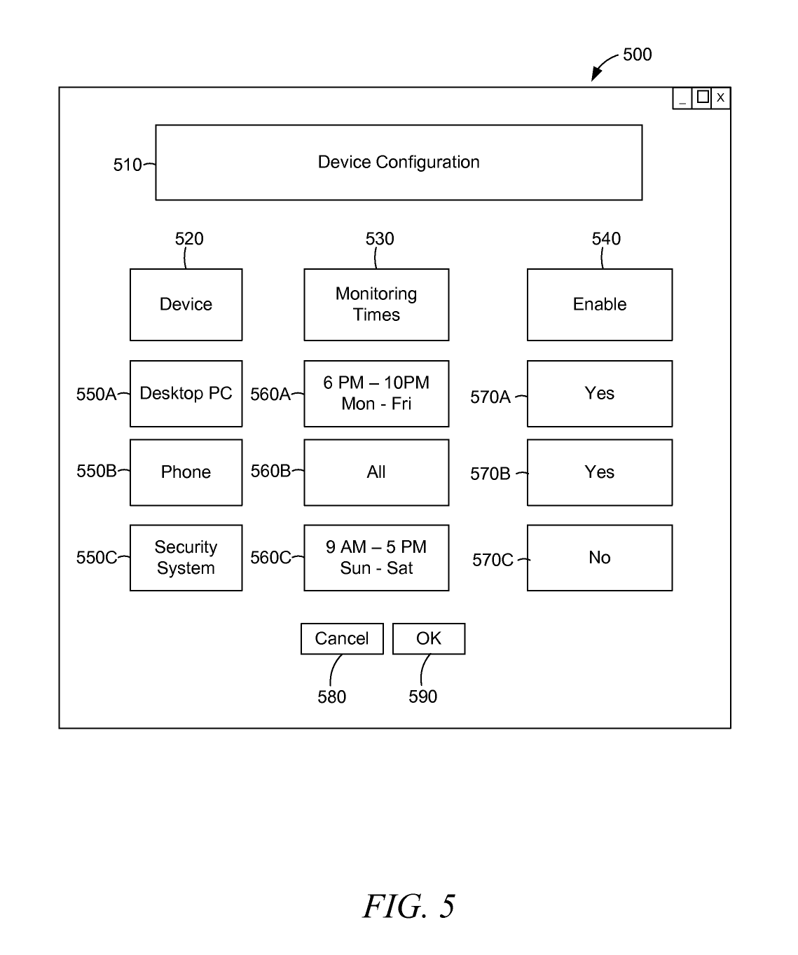

FIG. 5 is a block diagram illustrating a user interface 500 suitable for targeted promotions, according to some example embodiments. As can be seen in the block diagram of FIG. 5, the user interface 500 includes title 510, headers 520-540, items 550A-570C, and buttons 580 and 590.

The title 510 can indicate the contents of the user interface screen. For example, the title of “Device Configuration” shown in FIG. 5 may indicate that the screen presents options for configuring devices to be used with targeted promotions.

The headers 520-540 can indicate the data being presented or options available for configuration for each device. As shown, the header 520 indicates that items 550A-550C identify devices used for monitoring conversations. The header 530 indicates that items 560A-560C identify times and days during which monitoring is permitted. The header 540 indicates that items 570A-570C identify whether monitoring by the corresponding device is permitted at all or is currently enabled.

The items 550A-550C identify three devices of the user that can monitor the user. Item 550A is labeled “Desktop PC” and may correspond to a stationary computer of the user. Item 550B is labeled “Phone” and may correspond to a mobile device of the user. Item 550C is labeled “Security System” and may correspond to a stationary internet appliance of the user.

The items 560A-560C identify monitoring times of the corresponding devices 550A-550C. Item 560A shows that the desktop PC device may monitor conversations between 6 PM and 10 PM, Monday through Friday. Item 560B shows that the phone device may monitor conversations at any time. Item 560C shows that the security system device may monitor conversations between 9 AM and 5 PM, any day of the week. The items 560A-560C may be operable by the user to change the monitoring times of the corresponding devices 550A-550C. For example, clicking on the item 560A may cause a pop-up window to appear containing a date/time selector. After interacting with the date-time selector, the times appearing in the item 560A may be updated to reflect the user's selections.

The items 570A-570C identify whether or not the corresponding devices 550A-550C are enabled to monitor conversations. Items 570A and 570B show that the corresponding devices 550A and 550B are enabled. Item 570C shows that the corresponding device 550C is disabled. The items 570A-570C may be operable to change the monitoring status of the corresponding devices 550A-550C. For example, the user may click on the item 570A to disable monitoring by the desktop PC device. Alternatively, the items 570A-570C may inform the user as to whether the corresponding device 550A-550C is currently monitoring. For example, if the user interface 500 is presented at noon on a Monday, both the desktop PC device and the phone device will be enabled to monitor conversations, but the security system device will not be, based on the monitoring times presented in items 560A-560C. In some example embodiments, additional data or options are presented. For example, both a global enable/disable option and a status indicator showing whether monitoring is currently taking place could be presented.

The buttons 580 and 590 may be operable to allow the user to discard or save changes made in the user interface 500, respectively. For example, the user may modify the monitoring times of a device, then realize that a mistake has been made, and press the button 580, labeled “Cancel,” to undo the changes.

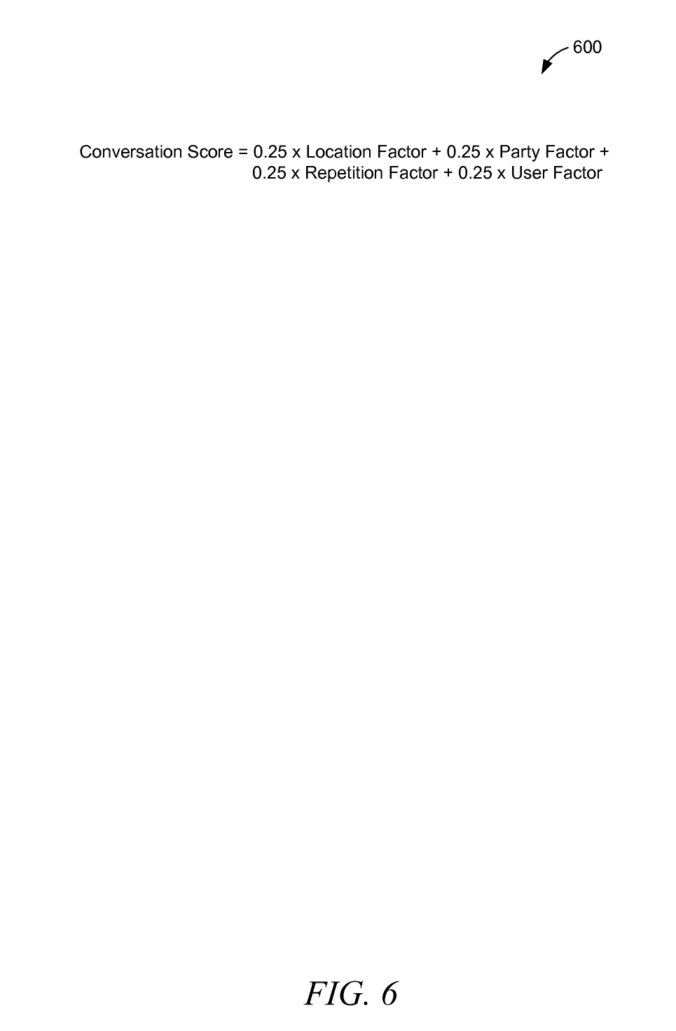

FIG. 6 is an equation 600 used in a method for targeted promotions, according to some example embodiments. In determining whether or not to present a targeted promotion based on a monitored conversation, a conversation score may be generated. The conversation score can be compared to a threshold, and the targeted promotion presented only if the conversation score exceeds the threshold. Various algorithms for determining the conversation score of a conversation may be used. The example algorithm in the equation 600 shows the conversation score being determined by a combination of a Location Factor, a Party Factor, a Repetition Factor, and a User Factor, with each of the four factors being given an equal weight of 0.25.

The Location Factor is based on the location at which the monitored conversation takes place. The location can be determined using a global positioning system (GPS) device of the client machine 110 or 112, using a configuration setting, or in some other way. For example, a smart appliance may be identified by the user as being at the user's home or office. The Location Factor for a given location may be based on a probability that important conversations take place at the location. For example, the user's home may have a Location Factor of 1.0, the user's work place may have a Location Factor of 0.75, and a local bar may have a Location Factor of 0.25.

The Party Factor is based on the parties to the monitored conversation. The parties to the conversation can be determined by voiceprint analysis, by identification of devices at the location associated with other parties, or in some other way. For example, the user's spouse may also be a user of the targeted promotion system. Based on monitoring of the user's spouse's conversations, a voiceprint for the user's spouse may be generated. Based on the voiceprint of the user's spouse, the user's spouse may be identified as a party to a monitored conversation of the user. The Party Factor for a given party may be based on a probability that the party's opinion influences the buying decisions of the user. For example, the user's spouse may have a Party Factor of 1.0, another individual with whom the user has frequent conversations may have a Party Factor of 0.8, and an unknown individual may have a Party Factor of 0.2.

Additional layers of organization may be used in determining the Party Factor of an influencer. For example, a party may be a member of a group, and the Party Factor may be defined by the membership in the group. To illustrate, a user's spouse, parents, and children may be members of the user's family, and so belong to a family group. The family group may be assigned a Party Factor of 1.0, and the members of the family can inherit that Party Factor rather than being assigned individual Party Factors.

The Party Factor of an influencer may also be impacted by whether or not the influencer is trusted by the influenced party. For example, a party can indicate one or more trusted people using a user interface. The trust relationships can be stored in a database. Based on the party being trusted, the Party Factor of the party can be increased. The trust relationship can also be inferred from other relationships. For example, a user of a social media network may indicate that another user is his spouse. Based on the spousal relationship, trust between the users may be inferred. Other relationships may also be used to infer trust. For example, relatives, co-workers, or members of groups may be inferred to trust each other. Trust can also be inferred based on an amount of time the parties spend together. For example, if the parties have communicated for more than an hour in the past week or if the parties have spent more than ten hours in the past week in close proximity, trust may be inferred. The threshold amounts of time spent together, date range over which the proximity is checked, and space over which “close proximity” is determined may be adjusted on an implementation or user basis. For example, one user may be deemed to trust anyone who has spent over ten hours within 100 feet over the past month while another user only trusts people who have spent over eight hours in the past week within 6 feet.

The Repetition Factor is based on a matching of keywords in the monitored conversation with keywords in previously monitored conversations. The repetition of keywords can be determined by comparing keywords in the monitored conversation with keywords of previously monitored conversations stored in a database. The previously monitored conversations may be conversations of the user or conversations of other users. For example, a trending item may be discussed in many conversations and given a higher Repetition Factor even if this is the first conversation in which the user has mentioned the item. As an example, the Repetition Factor for a conversation involving an item that has been detected in monitored conversations of the user twice before in the past week may be 1.0. As another example, the Repetition Factor for a conversation involving an item that is not currently trending and has not been previous mentioned by the user may be 0.0.

The User Factor is based on a matching of keywords in the monitored conversation with other information known about the user. The matching of keywords can be determined by comparing keywords in the monitored conversations, or interests related to those keywords, with a database of other activities by the user. For example, a user may have searched for a product on an online marketplace prior to having the monitored conversation in which the product is mentioned. Based on the prior indication of interest by the user, the User Factor may be increased. As an example, the User Factor for a conversation involving an interest about which the user has spent an hour researching in an online marketplace that same day may be 1.0. As another example, the User Factor for a conversation involving an interest that the user has spent 5 minutes searching for using a search engine may be 0.5.

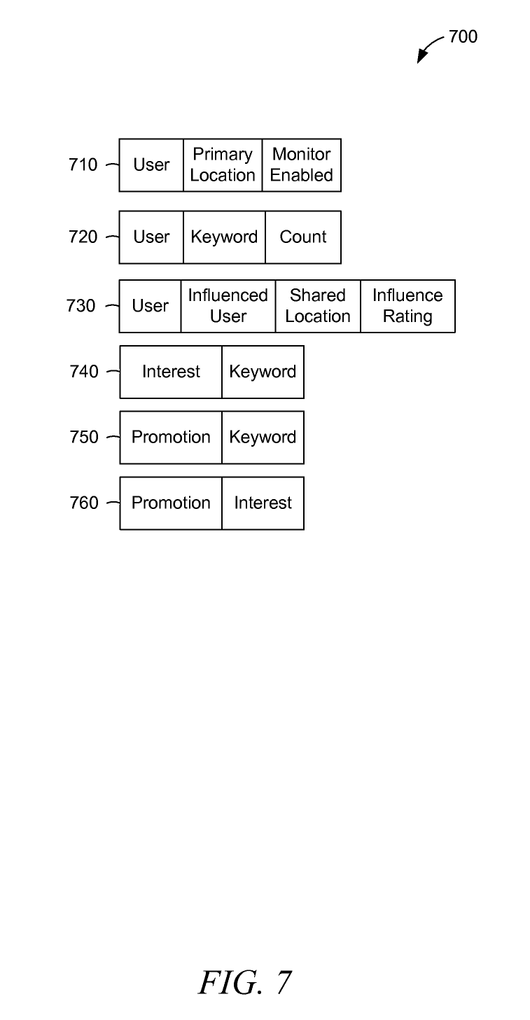

FIG. 7 is a block diagram 700 illustrating data structures, according to some example embodiments, suitable for targeted promotions. The data structures 710-730 store data for a user in a database. The data structure 740 stores data for an interest in a database. The data structures 750 and 760 store data for a promotion in a database. The data structures 710-760 may be stored in the same database or in different databases.

The data structure 710 stores user information, such as a user name, identifier, address, phone number, birth date, occupation, marital status, income, and so on. The data structure 710 indicates a primary location of the user. For example, the user's home address may be indicated as the user's primary location. As discussed above, the conversation score of a conversation may be based in part on the location of the conversation, such as by whether the conversation occurs at the user's primary location. The data structure 710 indicates whether monitoring is enabled. For example, a user with privacy concerns may selectively disable monitoring. Additional configuration options for the user may also be stored in the data structure 710.

The data structure 720 stores information regarding a user's previous conversations, such as a count of the number of recurrences of a keyword. Multiple data structures 720 may exist for a user, one for each keyword. The data structure 720 may also store time stamp information. For example, the date and time of the last conversation in which the keyword was used. In some example embodiments, an interest rather than a keyword is stored.

The data structure 730 stores information regarding a user's influence on other users. Multiple data structures 730 may exist for a user, one for each user influenced by the user. The data structure 730 can indicate the influencing user, the influenced user, a shared location for the two users, and an influence rating of the influencing user on the influenced user. The influence rating may be the Party Factor of the Conversation Score discussed above with respect to FIG. 5, a component of the Party Factor, or an independent value. In determining the Conversation Score of a conversation, the weight given to the influencing user may be increased when the conversation takes place at the shared location of the two users. This can be reflected by modifying the Party Factor, the Location Factor, or both. For example, a conversation with the user's boss may have a Party Factor of 0.8 when at a location other than the shared location of the user's work place and a Party Factor of 1.0 when at the shared location.

The data structure 740 stores information regarding an interest. Multiple data structures 740 may exist for an interest, one for each keyword associated with the interest. The data structure 740 can indicate an interest and a keyword associated with the interest. Based on a conversation including the keyword, the interest can be associated with the conversation.

The data structure 750 stores information regarding a promotion. Multiple data structures 750 may exist for a promotion, one for each keyword associated with the promotion. The data structure 750 can indicate the promotion and a keyword associated with the promotion. Based on a conversation including a keyword, the associated promotion may be selected for presentation to the user or to other parties to the user's conversations.

The data structure 760 stores information regarding a promotion. Multiple data structures 760 may exist for a promotion, one for each interest associated with the promotion. The data structure 760 can indicate the promotion and an interest associated with the promotion. Based on a conversation indicating the user's interest, the associated promotion may be selected for presentation to the user or to other parties to the user's conversations.

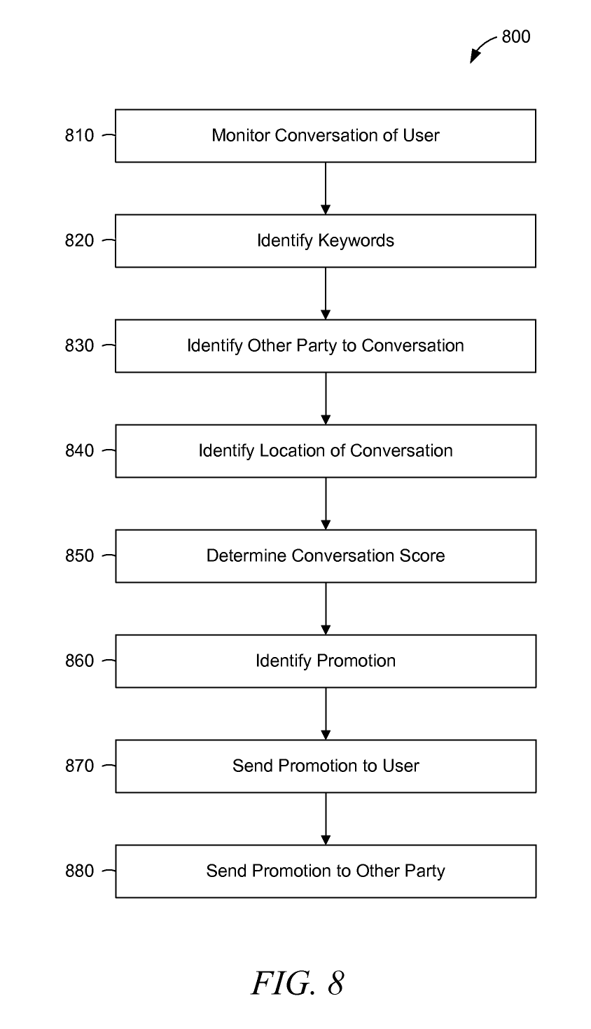

FIG. 8 is a flowchart illustrating operations of an application server 118 and client machine 110 or 112 in performing methods of presenting targeted promotions, according to some example embodiments. Operations in the method 800 may be performed by the application server 118 using modules described above with respect to FIG. 2 and the client machine 110 or 112 using modules described above with respect to FIG. 3. As shown in FIG. 8, the method 800 includes operations 810, 820, 830, 840, 850, 860, 870, and 880.

In operation 810, the monitor module 330 of the client machine 110 or 112 monitors a conversation of a user. For example, a user may be at home, speaking to his spouse regarding needed repairs on a car.

In operation 820, the monitor module 330 identifies keywords in the monitored conversation. For example, “repair,” “replace,” and “buy” may be keywords indicating that the user is interested in or open to buying an item. Similarly, “car” may be a keyword indicating that the user is discussing cars.

In operation 830, the monitor module 330 identifies a party to the conversation other than the user. For example, the spouse of the user may be identified based on a voiceprint or a determination that a device of the spouse is in close proximity to the client machine 110 or 112. In some example embodiments, before proceeding, a determination is made as to whether the identified party has influence on the user. If the identified party does not have influence on the user, the process may be stopped and no promotion sent. For example, a database can be accessed that includes data structure 730, indicating the influence relationship between users. Based on the presence of a record showing that the identified party influences the user, the method may proceed with operation 840.

In some example embodiments, identification of the party is performed based on probabilities. For example, no exact voiceprint match may be found, but some matches may be closer than others and a probability assigned to the match. Additional criteria may be used to determine the most likely party to the conversation. For example, the user and the spouse may use a calendaring application accessible by the application server 118. If the calendaring application shows that both the user and the spouse are attending the same event at the current time, the probability that the other party is the spouse can be increased. Alternatively, if the calendaring application shows that the user and the spouse are scheduled to attend different events at the current time, the probability that the other party is the spouse can be decreased. When probabilities are used, the identified individual with the greatest probability may be treated as the identified party. Additionally or alternatively, a minimum threshold may be applied, such that if no potential match has a higher probability than the threshold, no party is identified.

In operation 840, the monitor module 330 identifies the location of the conversation. For example, if the monitor module 330 is part of a stationary device such as a desktop computer or a smart appliance, the location of the conversation may be pre-configured. As another example, the monitor module 330 may have access to a GPS device or module. Using the GPS module, the location of the conversation may be determined. For example, the location of the conversation in GPS coordinates can be compared to known coordinates of important locations for the user such as home or work.

In operation 850, the promotion module 240 or 350 determines a conversation score for the monitored conversation. For example, the equation 600 can be used to determine a conversation score based on the location of the conversation, the participants in the conversation, the repetition of terms used in the conversation, and information known about the user.

In operation 860, the promotion module 240 or 350 identifies a promotion to present in response to the monitored conversation. The decision to identify a promotion may be based on the conversation score determined in operation 850. The promotion to present may be based on keywords identified in operation 820. For example, a database containing the data structures shown in FIG. 7 may be accessed and promotions identified by keyword using the data structure 750. Additionally or alternatively, the promotion to present may be based on interests of the user determined based on keywords identified in operation 820. For example, the keywords can be mapped to interests using the data structure 740, and the interests mapped to promotions using the data structure 760.

The promotions to be presented can be for individual items, such as a particular make, model, and year of car. Additionally, the promotions to be presented can be for categories of items, such as cars in general, or for sub-categories of items, such as four-door sedans manufactured in the last 5 years. Promotions can be based on items purchased or otherwise interacted with by people in the user's social network. The depth and breadth of searching may be configurable by the user or an administrator. For example, searching may be limited to first-degree friends of the user or extended out to higher degrees. Similarly, searching may be limited to items directly corresponding to keywords monitored in the conversation, to items corresponding to interests identified based on keywords in the conversation, or extend out to higher degrees of indirection. For example, based on an interest in a particular sub-category, searching may be performed that encompasses the category of which the sub-category is a part, other sub-categories that are related to the sub-category, or other categories that are related to the category.

Promotions may also be identified based on the price of the promoted item or prices detected in the conversation. For example, a user with a higher income may be presented promotions for more expensive items than a user with a lower income. As another example, if $500 is mentioned in a conversation regarding a television, promotions for televisions in the $500 price range may be selected.

In operation 870, the promotion module 240 or 350 sends the identified promotion to the user. For example, the identified promotion may be for a lease on a new Honda. The promotion may be presented to the user by the user interface module 320, or sent to the user via another communication channel (e.g., text message, email, voicemail, and the like).

In operation 880, the promotion module 240 or 350 sends the identified promotion to the other participant in the conversation. For example, the identified promotion may be presented to the other participant by a user interface module 320 of a device associated with the other participant, or sent to the other participant via another communication channel.

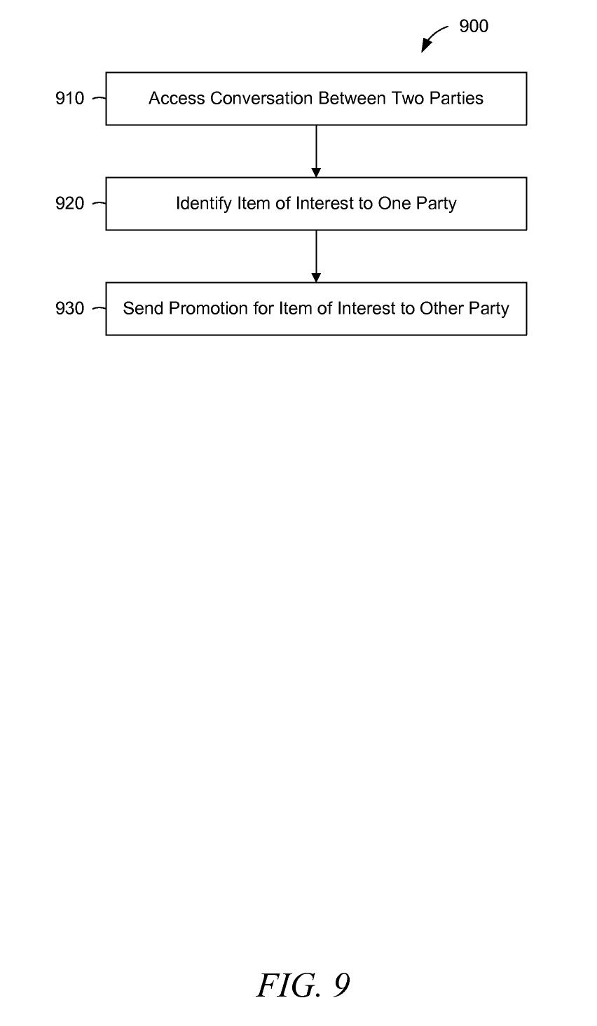

FIG. 9 is a flowchart illustrating operations of an application server 118 and client machine 110 or 112 in performing methods of presenting targeted promotions, according to some example embodiments. Operations in the method 900 may be performed by the application server 118 using modules described above with respect to FIG. 2 and the client machine 110 or 112 using modules described above with respect to FIG. 3. As shown in FIG. 9, the method 900 includes operations 910, 920, and 930.

In operation 910, the monitor module 330 of the client machine 110 or 112 monitors a conversation of two parties. For example, a user may be at work, speaking to a co-worker regarding a desired smart phone upgrade.

In operation 920, the monitor module 330 identifies items of interest to one party. For example, “upgrade,” “replace,” and “buy” may be keywords indicating that the user is interested in or open to buying an item. Similarly, “phone” may be a keyword indicating that the user is discussing smart phones. Accordingly, a new smart phone may be an item of interest to the user.

In operation 930, the promotion module 240 or 350 sends a promotion for the item to a party to the conversation other than the user. For example, an advertisement for a particular make and model of new phone can be sent to the other participant in the conversation. Advertisers may find this advantageous because the other participant may share the promotion with the user. The user may respond to a shared recommendation more positively than a directly-received promotion.

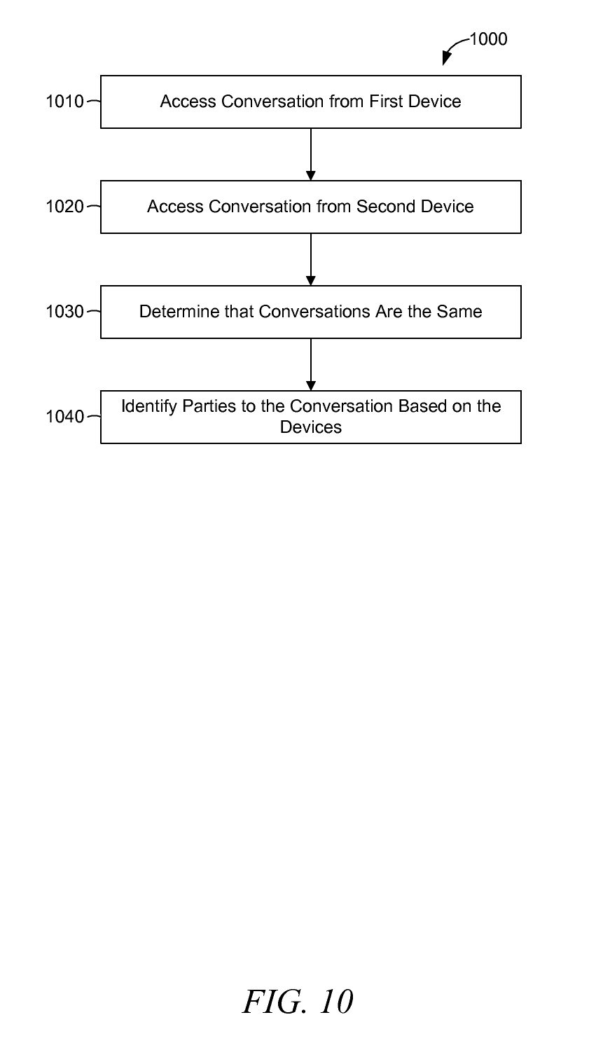

FIG. 10 is a flowchart illustrating operations of an application server 118 and client machine 110 or 112 in performing methods of presenting targeted promotions, according to some example embodiments. Operations in the method 1000 may be performed by the application server 118 using modules described above with respect to FIG. 2 and the client machine 110 or 112 using modules described above with respect to FIG. 3. As shown in FIG. 10, the method 1000 includes operations 1010, 1020, 1030, and 1040.

In operation 1010, the monitor module 330 of a first client machine 110 or 112 monitors a conversation. For example, a user may be at home, speaking to his spouse regarding needed repairs on a car. The first client machine 110 or 112 may be a portable computing device associated with the user, such as a smart phone. Alternatively, the first client machine 110 or 112 may be a computing device at a fixed location, such as a smart appliance located at the home of the user.

In operation 1020, the monitor module 330 of a second client machine 110 or 112 monitors a conversation. For example, a user may be at home, speaking to her spouse regarding needed repairs on a car. The second client machine 110 or 112 may be a portable computing device associated with the user, such as a smart phone. Alternatively, the second client machine 110 or 112 may be a computing device at a fixed location, such as a smart appliance located at the home of the user.

In operation 1030, the identification module 230 or 350 determines that the conversations monitored by the first and second client machines are the same conversation. For example, the GPS locations of the two devices may be in close proximity to each other and the determination made based on the GPS locations. As another example, the conversations may have the same content. For example, the conversations can be matched based on the text generated by speech-to-text conversion or based directly on matching of the raw sound data.

In operation 1040, the identification module 230 or 350 determines that the parties to the conversation are the parties associated with the first and second devices. For example, if both devices are mobile devices, the parties to the conversation can be determined to be the owners or primary users of the mobile devices. As another example, if one device is in a fixed location associated with one party, that party can be determined to be a participant in the conversation.

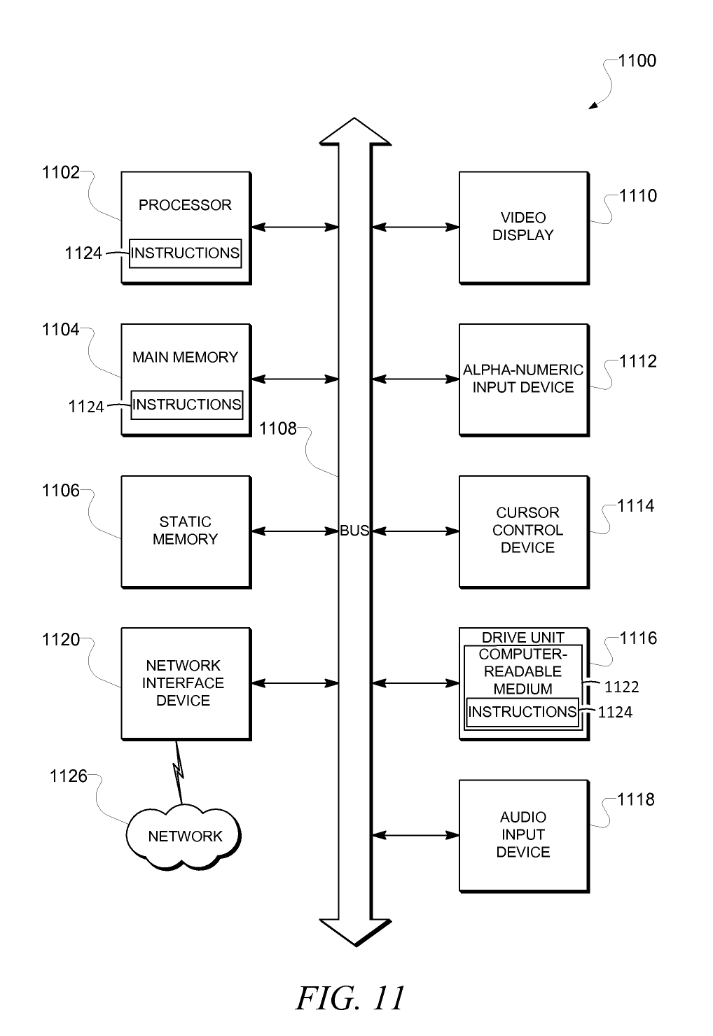

FIG. 11 is a block diagram illustrating components of a machine 1100, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 11 shows a diagrammatic representation of the machine 1100 in the example form of a computer system within which instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a set-top box (STB), a personal digital assistant (PDA), a cellular telephone, a smartphone, an internet appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a video display 1110 (e.g., a plasma display panel (PDP), a light emitting diode (LED) display, a liquid crystal display (LCD), a projector, or a cathode ray tube (CRT)). The machine 1100 may also include an alpha-numeric input device 1112 (e.g., a keyboard), a cursor control device 1114 (e.g., a mouse, a touchpad, a trackball, a joystick, a motion sensor, or other pointing instrument), a drive unit 1116, an audio input device 1118 (e.g., a microphone), and a network interface device 1120.

The storage unit 1116 includes a machine-readable medium 1122 on which is stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 (e.g., network 104) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a communication between a first party and a second party;
based on the communication, identifying an item that is of interest to the first party; and
based at least in part on the item being of interest to the first party, communicating a promotion for the item for presentation to the second party, wherein the communicating is performed by a processor.

2. The method of claim 1, further comprising identifying a set of parties with influence on the first party; and
wherein the second party is a member of the identified set of parties.

3. The method of claim 1, wherein:
the communication is an in-person voice communication; and
the first party and the second party are individuals.

4. The method of claim 3, wherein the first party and the second party are members of a family.

5. The method of claim 1, wherein the accessing of the communication includes recording a conversation received by a microphone.

6. The method of claim 1, wherein the microphone is part of a smartphone, wearable device, or internet appliance.

7. The method of claim 1, wherein the identifying of the item is based on keywords in the communication.

8. The method of claim 1, further comprising identifying the first party and the second party.

9. The method of claim 8, wherein:
the accessing of the communication includes recording a conversation received by a microphone attached to a first computing device associated with the first party;
the identifying of the first party is based on an identification of the first computing device; and
the identifying of the second party is based on a determination of a location of a second computing device associated with the second party.

10. The method of claim 9, further comprising determining a location of the first computing device; and
wherein the identifying of the second party is further based on a determination that that the location of the second computing device is within a predetermined distance from the first computing device.

11. The method of claim 8, wherein:
the accessing of the communication includes recording a conversation, the conversation received by a first microphone attached to a first computing device associated with the first party, the conversation received by a second microphone attached to a second computing device associated with the second party;
the identifying of the first party is based on an identification of the first computing device; and
the identifying of the second party is based on an identification of the second computing device.

12. The method of claim 1, further comprising determining that the second party is trusted by the first party.

13. The method of claim 12, wherein the determination that the second party is trusted by the first party is based on the first party having indicated that the second party is a spouse or a relative.

14. The method of claim 12, wherein the determination that the second party is trusted by the first party is based on a determination that an amount of time the first party and the second party have spent in conversation exceeds a threshold.

15. The method of claim 12, wherein the determination that the second party is trusted by the first party is based on a determination that an amount of time the first party and the second party have spent within a predetermined proximity exceeds a threshold.

16. The method of claim 1, further comprising determining a conversation score for the communication; and wherein
the communicating of the promotion for the item for presentation to the second party is based at least in part on the conversation score exceeding a threshold.

17. The method of claim 16, wherein the conversation score is based at least in part on a location of the communication.

18. A system comprising:
a monitor module configured to access a communication between a first party and a second party;
an interest module configured to identify an item that is of interest to the first party, based on the communication; and
a promotion module configured to communicate a promotion for the item for presentation to the second party based at least in part on the item being of interest to the first party.

19. The system of claim 18, wherein two or more of the monitor module, the interest module, and the promotion module are merged into a single module.

20. A non-transitory machine-readable medium having instructions embodied thereon, the instructions executable by a processor of a machine to perform operations comprising:
accessing a communication between a first party and a second party;
based on the communication, identifying an item that is of interest to the first party; and
based at least in part on the item being of interest to the first party, communicating a promotion for the item for presentation to the second party.
